(19) United States
(12) Patent Application Publication
(10) Pub. No.: US 2014/0010368 A1
(43) Pub. Date: Jan. 9, 2014

(54) WIRELESS COMMUNICATION SYSTEM, TERMINAL, AND STORAGE MEDIUM

(71) Applicant: Kohki OHHIRA, Tokyo (JP)

(72) Inventor: Kohki OHHIRA, Tokyo (JP)

(73) Assignee: RICOH COMPANY, LTD., Tokyo (JP)

(21) Appl. No.: 13/933,238

(22) Filed: Jul. 2, 2013

(30) Foreign Application Priority Data
Jul. 6, 2012 (JP) 2012-152583

(51) Int. Cl. H04W 12/08

(52) U.S. Cl. CPC H04W 12/08
USPC 380/270

(57) ABSTRACT

A wireless communication system includes a plurality of transmitters each configured to transmit transmission information including a code and an identifier of the corresponding transmitter, and a plurality of terminals configured to wirelessly communicate with each other. Each of the terminals includes an obtaining unit that obtains codes extracted from multiple sets of the transmission information transmitted from the transmitters, and a communication unit that performs encrypted communications with other terminals using the obtained codes.

### CROSS-REFERENCE TO RELATED APPLICATION

The present application is based upon and claims the benefit of priority of Japanese Patent Application No. 2012-152583, filed on Jul. 6, 2012, the entire contents of which are incorporated herein by reference.

### BACKGROUND OF THE INVENTION

1. Field of the Invention

An aspect of this disclosure relates to a wireless communication system, a terminal, and a storage medium.

2. Description of the Related Art

In wireless communications between terminals, encryption technologies are used to make the communications confidential between the participating terminals. To perform encrypted communications, communication terminals participating in the encrypted communications need to retain a common number sequence called an encryption key, which is not known to others. For example, the following methods may be used to exchange an encryption key without letting others know the encryption key:
The user manually enters an encryption key without allowing others to see the encryption key.
Use public key cryptography or a digital certificate technology that is an application of the public key cryptography.
Enter a short number sequence called PIN code while visually checking it.
Press buttons at the same timing at different terminals to authenticate each other and exchange a number sequence.

Also, Japanese Laid-Open Patent Publication No. 2005-018487 discloses a technology for maintaining the security of information in a meeting. According to the disclosed technology, a participation right is distributed to computers on a network every time a participant entering or leaving a meeting room is detected based on in-and-out information of the meeting room.

### SUMMARY OF THE INVENTION

In an aspect of this disclosure, there is provided a wireless communication system that includes a plurality of transmitters, each configured to transmit transmission information including a code and an identifier of the corresponding transmitter, and a plurality of terminals configured to wirelessly communicate with each other. Each of the terminals includes an obtaining unit that obtains codes extracted from multiple sets of the transmission information transmitted from the transmitters, and a communication unit that performs encrypted communications with other terminals using the obtained codes.

### BRIEF DESCRIPTION OF THE DRAWINGS

FIG. 1 is a drawing illustrating an exemplary configuration of a wireless communication system;

FIG. 2 is a block diagram illustrating an exemplary configuration of a transmitter;

FIG. 3 is a block diagram illustrating an exemplary configuration of a receiver;

FIG. 4 is an external view of an exemplary receiver;

FIG. 5 is an external view of another exemplary receiver;

FIG. 6 is a block diagram illustrating an exemplary configuration of a terminal;

FIG. 7 is a block diagram illustrating an exemplary functional configuration of a controller according to a first embodiment;

FIG. 8 is a drawing illustrating an example of a limited communication range;

FIG. 9 is a drawing illustrating another example of a limited communication range;

FIG. 10 is a timing chart illustrating transmission timing of transmitters;

FIG. 11 is a drawing illustrating an example of transmission information;

FIG. 12 is a drawing illustrating another example of transmission information;

FIG. 13 is a drawing illustrating another example of transmission information;

FIG. 14 is a flowchart illustrating an exemplary transmission process performed by a transmitter;

FIG. 15 is a flowchart illustrating an exemplary reception process performed by a receiver;

FIG. 16 is a flowchart illustrating an exemplary communication setting process performed by a terminal according to the first embodiment;

FIG. 17 is a block diagram illustrating an exemplary functional configuration of a controller according to a second embodiment; and

FIG. 18 is a flowchart illustrating an exemplary communication setting process performed by a terminal according to the second embodiment.

### DESCRIPTION OF THE PREFERRED EMBODIMENTS

With the related-art encryption key exchange methods described above, a user needs to explicitly operate a terminal to, for example, authentication information. Also, the technology disclosed in Japanese Laid-Open Patent Publication No. 2005-018487 is only applicable to a closed space, such as a meeting room, because the technology requires a mechanism to manage entering and leaving of participants based on, for example, opening and closing of a door.

Thus, with the related-art technologies, it is difficult to easily and quickly perform authentication to conduct secure communications in a given (or limited) area that is not necessarily a closed space. An aspect of this disclosure makes it possible to prevent or reduce one or more problems caused by the limitations and disadvantages of the related art.

Preferred embodiments of the present invention are described below with reference to the accompanying drawings.

### First Embodiment

### <System>

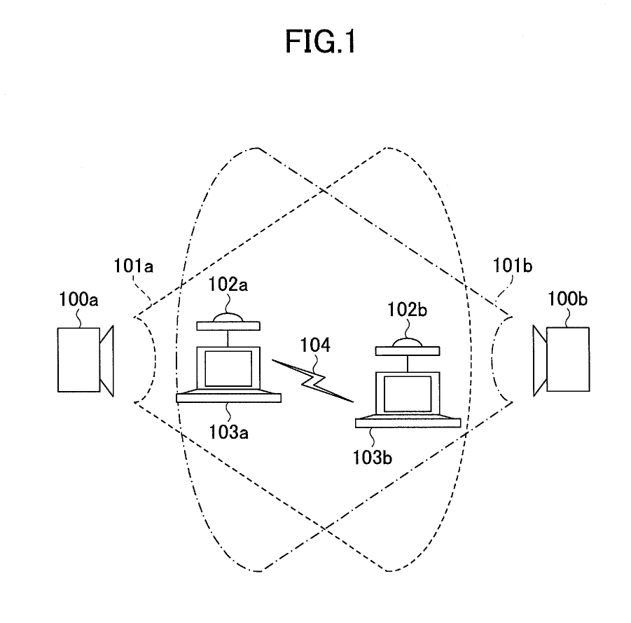

FIG. 1 is a drawing illustrating an exemplary configuration of a wireless communication system. The wireless communication system of FIG. 1 may include transmitters 100a and 100b, receivers 102a and 102b, and terminals 103a and 103b.

The transmitters 100a and 100b have substantially the same configurations and therefore may be collectively referred to as a transmitter 100 and transmitters 100. Similarly, the receivers 102a and 102b may be collectively referred to as a receiver 102 and receivers 102, and the terminals 103a and 103b may be collectively referred to as a terminal 103 and terminals 103.

The transmitters 100a and 100b transmit transmission information in predetermined ranges. In FIG. 1, reference numbers 101a and 101b indicate transmission ranges of the transmitters 100a and 100b, respectively. The transmission information includes at least an identifier (identification information) of the corresponding transmitter 100 and a code such as a random number.

The receivers 102a and 102b are connected to the corresponding terminals 103a and 103b. The receivers 102a and 102b receive transmission information from the transmitters 100, and send the transmission information or key information generated based on the transmission information to the corresponding terminals 103a and 103b.

The terminals 103a and 103b perform authentication based on the information obtained or received from the receivers 102a and 102b and wirelessly communicate with each other when the authentication is successful.

For example, the transmitters 100 transmit random values at different cycles, and the receivers 102 receive the random values and transfer the received random values to the terminals 103. The terminals 103 use the random numbers as an encryption key to perform encrypted communications 104. The receiver 102 may be incorporated in the terminal 103.

### <Transmitter>

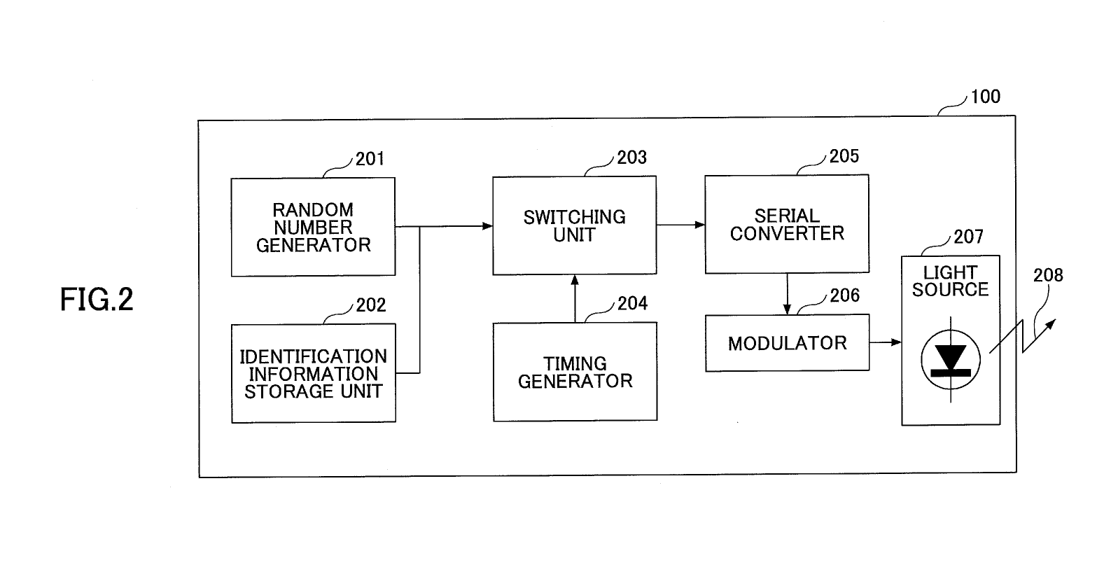

Next, the transmitter 100 is described. FIG. 2 is a block diagram illustrating an exemplary configuration of the transmitter 100. As illustrated by FIG. 2, the transmitter 100 may include a random number generator 201, an identification information storage unit 202, a switching unit 203, a timing generator 204, a serial converter 205, a modulator 206, and a light source 207.

The random number generator 201 generates a random number. The random number generator 201 may be configured to generate random numbers at predetermined intervals. Hereafter, a value obtained by binarizing a random number is referred to as a “random value”. For example, a random value may be expressed by 128 to 1024 bits. In the descriptions below, a random value is used as an example of a code.

The identification information storage unit 202 stores an identifier (identification information) that is unique to the transmitter 100. The identifier may be represented by a 48-bit number sequence according to an addressing system called EUI-48, which is defined by the Institute of Electrical and Electronic Engineers (IEEE). The higher 24 bits of the 48 bits are used for a value called an organizationally unique identifier (OUI) that is assigned to each manufacturer, and the lower 24 bits are used for a number assigned by the manufacturer to uniquely identify each device of the manufacturer.

The random value generated by the random number generator 201 and the identifier (e.g., EUI-48) retrieved from the identification information storage unit 202 are combined and sent to the switching unit 203.

The switching unit 203 switches between transmitting and not transmitting transmission information including the random value and the identifier based on a timing signal input from the timing generator 204. In the transmission information, for example, the identifier may be attached next to the random number. The timing generator 204 includes a timer and outputs a transmission request to the switching unit 203 at predetermined timing.

More specifically, when determining that it is the timing to transmit transmission information, the timing generator 204 outputs a transmission request to cause the switching unit 203 to send the random value and the identifier. When receiving the transmission request from the timing generator 203, the switching unit 203 sends the transmission information to the serial converter 205.

The serial converter 205 converts number sequences in the transmission information into a temporally-sequential digital signal and sends the digital signal to the modulator 206.

The modulator 206 generates a power waveform for driving the light source 207 based on the digital signal, and applies the power waveform to the light source 207.

The light source 207 emits light that diverges at a predetermined illuminating angle. The light source 207 transmits an optical signal 208 corresponding to the transmission information. For example, light beams may be emitted from two or more transmitters such that the light beams intersect with (or overlap) each other to form an area.

The light source 207 is driven by the modulator 206 and transmits the transmission information via intensity-modulated light. The light source 207 may be implemented, for example, by a light emitting diode (LED) that emits visible light or invisible light (e.g., infrared light).

Thus, the light source 207 functions as a transmitting unit for transmitting transmission information. Also, multiple components including the light source 207 may be collectively referred to as a transmitting unit. For example, the transmitter 100 may be referred to as a transmitting unit.

With the above described configuration, the transmitter 100 transmits transmission information including a code (e.g., a random value) and an identifier of the transmitter 100 via light emitted by the light source 207. The light source 207 may be replaced with a device that outputs a sonic wave or an ultrasonic wave.

### <Receiver>

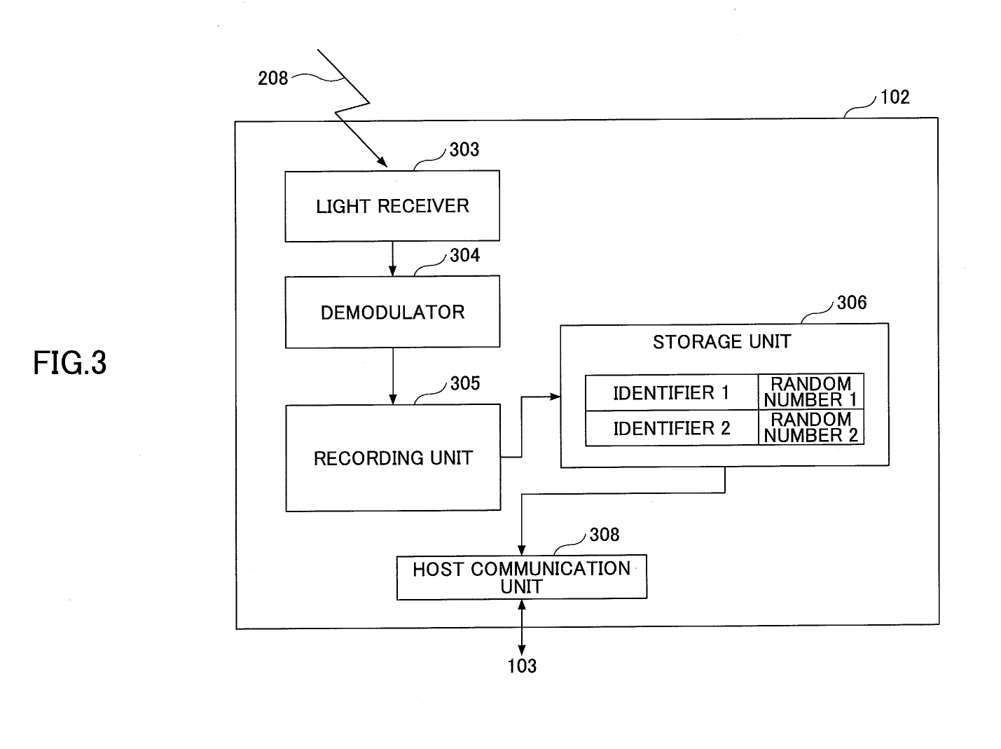

Next, the receiver 102 is described. FIG. 3 is a block diagram illustrating an exemplary configuration of the receiver 102. As illustrated by FIG. 3, the receiver 102 may include a light receiver 303, a demodulator 304, a recording unit 305, a storage unit 306, and host communication unit 308.

The light receiver 303 receives the optical signal 208 representing the transmission information transmitted from the transmitter 100. The light receiver 303 converts the received optical signal 208 into waveform data representing electric power values and outputs the waveform data to the demodulator 304.

The demodulator 304 converts the waveform data into number sequences and outputs the number sequences to the recording unit 305.

The recording unit 305 stores, in the storage unit 306, the identifier of the transmitter 100 and the random value (code) included in the number sequences in association with each other. For example, random values corresponding to different identifiers are stored in different storage areas in the storage unit 306.

The storage unit 306 stores random values in association with the corresponding identifiers obtained from multiple sets of transmission information. For example, the recording unit 305 causes the storage unit 306 to store random values in association with the corresponding identifiers extracted from number sequences.

The contents of the storage unit 306 illustrated in FIG. 3 are based on the configuration of the wireless communication system illustrated by FIG. 1. In the exemplary configuration of FIG. 1, two transmitters 100 with different identifiers are provided in the wireless communication system. Therefore, in the example of FIG. 3, the storage unit 306 stores two random values in association with the identifiers of the transmitters 100.

Here, the two random values are referred to as a random number 1 and a random number 2. In FIG. 3, the random number 1 is associated with an identifier 1 and the random number 2 is associated with an identifier 2. The random number 1 and the random number 2 may be collectively referred to as “key information”. The key information may be obtained, for example, by concatenating the random number 1 and the random number 2.

The host communication unit 308 reads the random number 1 and the random number 2 from the storage unit 306 and send the random numbers 1 and 2 (i.e., key information) to the terminal 103. As an alternative configuration, the recording unit 305 and the storage unit 306 may be included in the terminal 103.

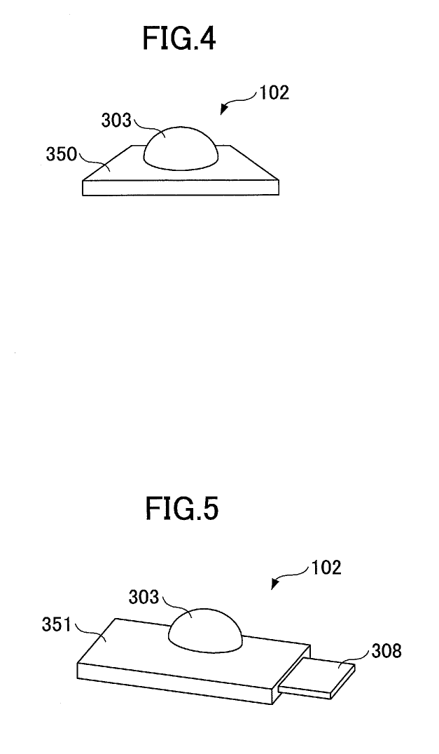

FIG. 4 is an external view of an example of the receiver 102. The receiver 102 of FIG. 4 may be roughly divided into the light receiver 303 and a part 350 including components other than the light receiver 303 illustrated in FIG. 3.

FIG. 5 is an external view of another example of the receiver 102. The receiver 102 of FIG. 5 may be roughly divided into the light receiver 303, the host communication unit 308, and a part 351 including components other than the light receiver 308 and the host communication unit 308 illustrated in FIG. 3. The receiver 102 of FIG. 5 may be implemented, for example, by attaching the light receiver 303 to a USB-connectable medium.

In the present embodiment, it is assumed that the receiver 102 of FIG. 4 is used. However, the receiver 102 may have a configuration as illustrated by FIG. 5 and may also have any configuration and shape as long as it includes components as illustrated in FIG. 3.

The light receiver 303 is an omnidirectional (or semi-omnidirectional) receiver that can receive an optical signal coming from above and from any one of 360-degree directions around the position where the light receiver 303 is installed. With this configuration, the receiver 102 can receive an optical signal regardless of its orientation.

### <Terminal>

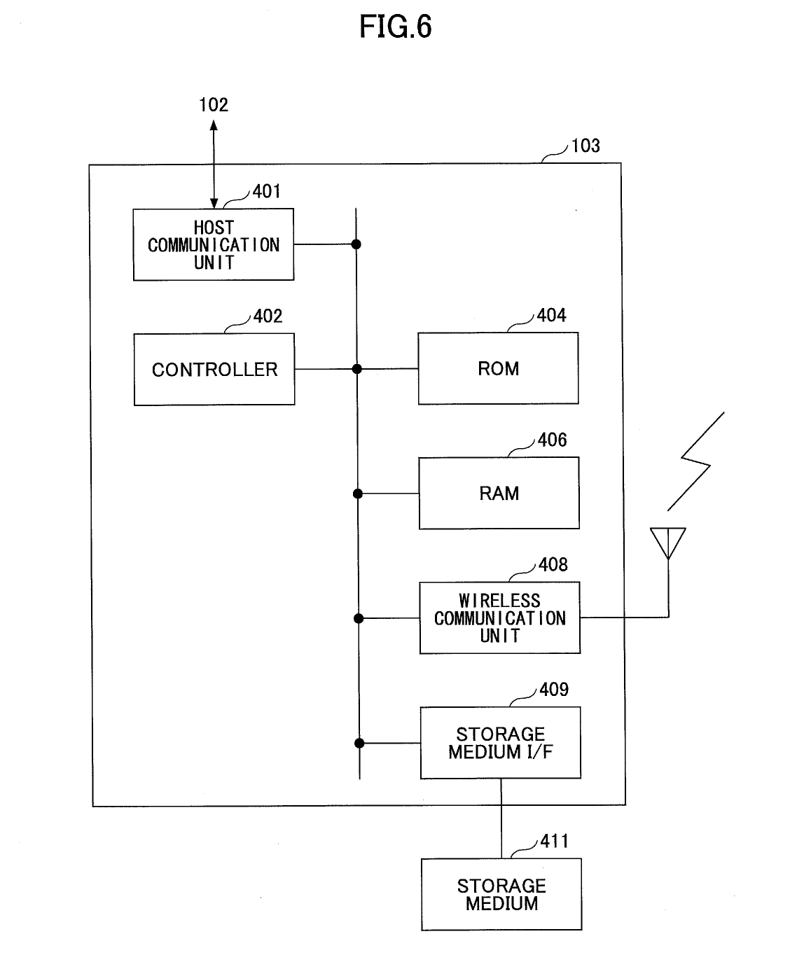

Next, the terminal 103 is described. FIG. 6 is a block diagram illustrating an exemplary configuration of the terminal 103. The terminal 103 may include a host communication unit 401, a controller 402, a read-only memory (ROM) 404, a random access memory (RAM) 406, a wireless communication unit 408, and a storage medium interface (I/F) 409. These components are connected to each other via a bus to enable transmission and reception of data.

The host communication unit 401 obtains or receives the key information sent from the receiver 102. The controller 402 executes programs loaded into the RAM 406 to implement various functions. The controller 402 is, for example, a central processing unit (CPU).

The ROM 404 stores, for example, programs and data used by the programs. The RAM 406 is used, for example, as a storage area into which programs are loaded and as a work area for the loaded programs.

The wireless communication unit 408 wirelessly communicates with other terminals 102 to, for example, send and receive a common encryption key for encrypted communications. The storage medium I/F 409 interfaces the terminal 103 and a (non-transitory) storage medium 411 (e.g., a flash memory, a CD-ROM, or a DVD) that are connected via a data transmission line such as a universal serial bus (USB).

For example, programs may be stored in the storage medium 411 and installed from the storage medium 411 in the ROM 404 via the storage medium I/F 409. The programs stored in the ROM 404 are executed by the controller 404 to implement various functions.

The recording unit 305 and the storage unit 306 illustrated in FIG. 3 may also be included in the terminal 103. Also, the receiver 102 may be incorporated in the terminal 103.

### <Functional Configuration>

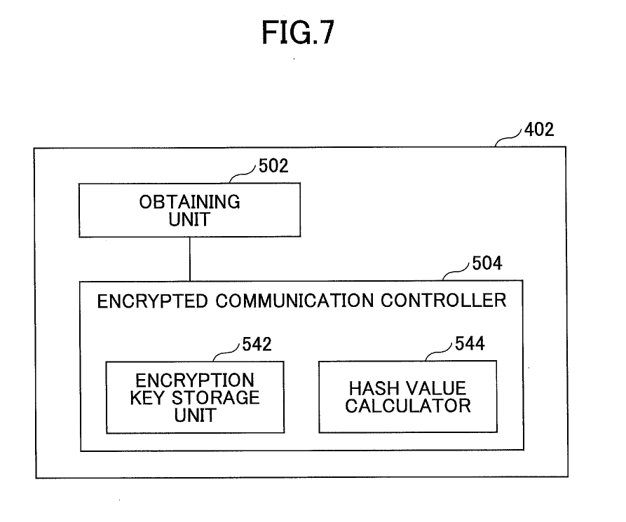

FIG. 7 is a block diagram illustrating an exemplary functional configuration of the controller 402 according to the first embodiment. As illustrated by FIG. 7, the controller 402 may include an obtaining unit 502 and an encrypted communication controller 504. The encrypted communication controller 504 may include an encryption key storage unit 542 and a hash vale calculator 544.

The obtaining unit 502 obtains or receives key information via the host communication unit 401 from the receiver 102. The obtaining unit 502 outputs the obtained key information to the encrypted communication controller 504.

The encrypted communication controller 504 encrypts communications performed by the terminal 103. The encrypted communication controller 504 stores the key information in the encryption key storage unit 542 as a common encryption key used for encrypted communications with another terminal 103.

The encrypted communication controller 504 controls encrypted communications between the terminal 103 and another terminal 103 using one encryption key that is based on the key information (two random values) received by the receiver 102. For example, the encrypted communication controller 504 uses one encryption key as a common encryption key. The common encryption key may be obtained by concatenating the random values in the key information or by performing a logical AND operation or a logical OR operation of the random values.

With the above configuration, a pair of receivers 102 that receive the same optical signals 208 and a pair of terminals 103 obtain and store a common encryption key, and the terminals 103 can communicate with each other using the common encryption key.

Here, there may be a case where the length of a number sequence obtained by concatenating the random number 1 and the random number 2 stored in the storage unit 306 differs from the length of a number sequence necessary for an encryption key (encryption key information). Also, when the number of transmitters 100 increases and the number of random values stored in the storage unit 306 increases, the length of a number sequence obtained by concatenating the random values increases.

However, it is preferable to make encryption keys (encryption key information) have a constant length defined by the encrypted communication controller 504. For this reason, when the length of key information (number sequence) is greater than a predefined (or desired) length (e.g., bit length) of encryption keys, the hash value calculator 544 puts the key information through a hash function to obtain a hash value with the predefined length, and the hash value is used as an encryption key.

In this case, the encrypted communication controller 504 controls encrypted communications using the encryption key obtained by the hash value calculator 544.

### <Communications in Limited Range>

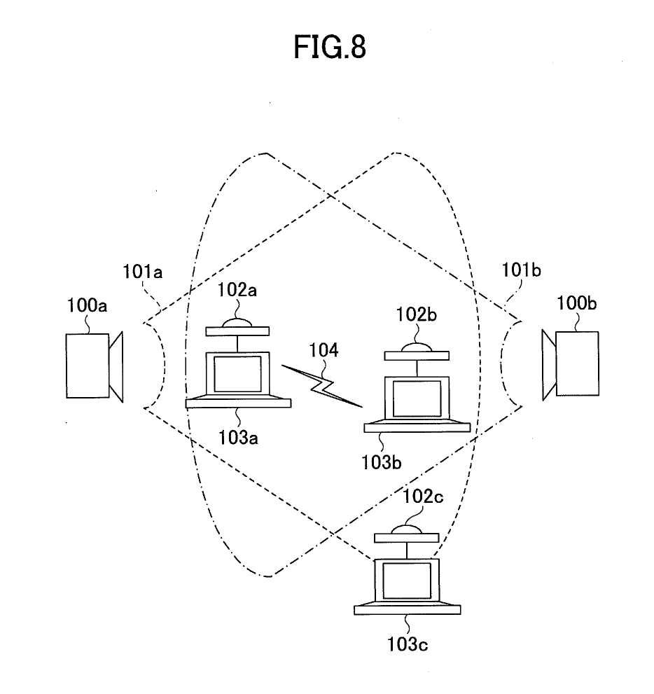

Next, methods for limiting a range or area of encrypted communications are described. FIG. 8 is a drawing illustrating an example of a limited communication range. In FIG. 8, similarly to FIG. 1, the transmitters 100a and 100b transmit random values and identifiers via optical signals. Reference numbers 101a and 101b in FIG. 8 indicate transmission ranges of the respective optical signals.

In the example of FIG. 8, receivers 102a and 102b are in both of the transmission ranges 101a and 101b, but a receiver 102c is only in the transmission range 101a. Accordingly, each of the receivers 102a and 102b receives the two optical signals from the transmitters 100a and 100b, extracts random values and identifiers from transmission information represented by the optical signals, and stores the random values in association with the corresponding identifiers. On the other hand, the receiver 102c receives only the optical signal from the transmitter 100a, extracts a random value and an identifier from transmission information represented by the optical signal, and stores the random value in association with the identifier.

Each of the receivers 102a and 102b concatenates the stored random values and sends the concatenated value as an encryption key for encrypted communications to the corresponding one of the terminals 103a and 103b. Meanwhile, the receiver 102c sends the stored random value as an encryption key to the terminal c.

Thus, the terminals 103a and 103b can obtain the same encryption key and therefore can perform encrypted communications 104 with each other.

On the other hand, because the encryption key of the terminal 103c is based only on the random value generated by the transmitter 100a, the encryption key of the terminal 103c is different from the encryption key of the terminals 103a and 103b. Accordingly, the terminal 103c cannot participate in the encrypted communications 104 between the terminals 103a and 103b.

As described above, encrypted communications can be limited in a range or area where transmission ranges of multiple transmitters overlap each other. Thus, the present embodiment makes it possible to limit the range or area of encrypted communications not only in a closed space but also in an open space.

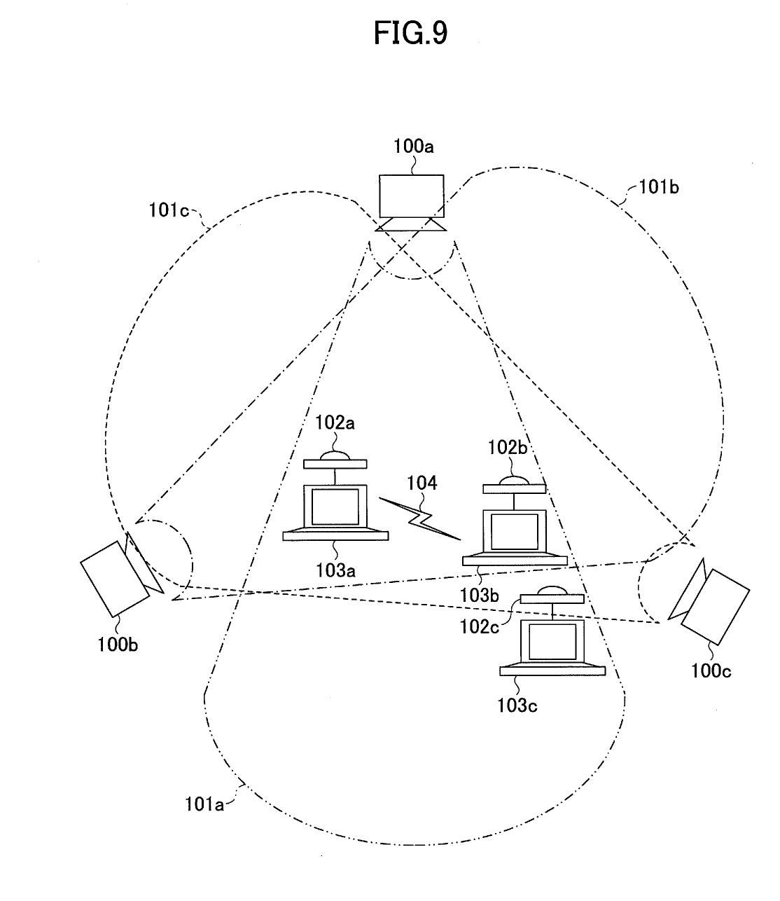

FIG. 9 is a drawing illustrating another example of a limited communication range. In the example of FIG. 9, three transmitters 100a, 100b, and 100c are provided. Reference numbers 101a, 101b, and 101c indicate the transmission ranges of the transmitters 100a, 100b, and 100c, respectively.

Similarly to the example of FIG. 8, receivers 102a, 102b, and 102c are provided and connected to terminals 103a, 103b, and 103c, respectively.

In the case of FIG. 9, three random values transmitted by the transmitters 100a, 100b, and 100c can be obtained only in a range or area where the transmission ranges 101a, 101b, and 101c overlap each other. An encryption key obtained based on the three random values is used for encrypted communications.

As illustrated in FIG. 9, the receivers 101a and 102b are in a range or area where the transmission ranges 101a, 101b, and 101c overlap each other and obtain the random values transmitted from the transmitters 100a, 100b, and 100c. Accordingly, the receivers 102a and 102b can obtain the same random number sequence (or a combination of three random values), and the terminals 103a and 103b connected to the receivers 102a and 102b can perform the encrypted communications 104 using the random number sequence as an encryption key.

On the other hand, the receiver 102c can obtain the random values transmitted by the transmitters 100a and 100c, but cannot obtain the random value transmitted by the transmitter 100b. Accordingly, an encryption key obtained by the terminal 103c becomes different from the encryption key of the terminals 103a and 103b, and the terminal 103c cannot perform encrypted communications with the terminals 103a and 103b.

Thus, even in an open space, an encrypted communication range can be limited further by increasing the number of transmitters 100. Meanwhile, it is also possible to limit an encrypted communication range using only one transmitter 100. In this case, only the terminals 103 whose receivers 102 are in the transmission range of the transmitter 100 can perform encrypted communications.

### <Transmission Timing>

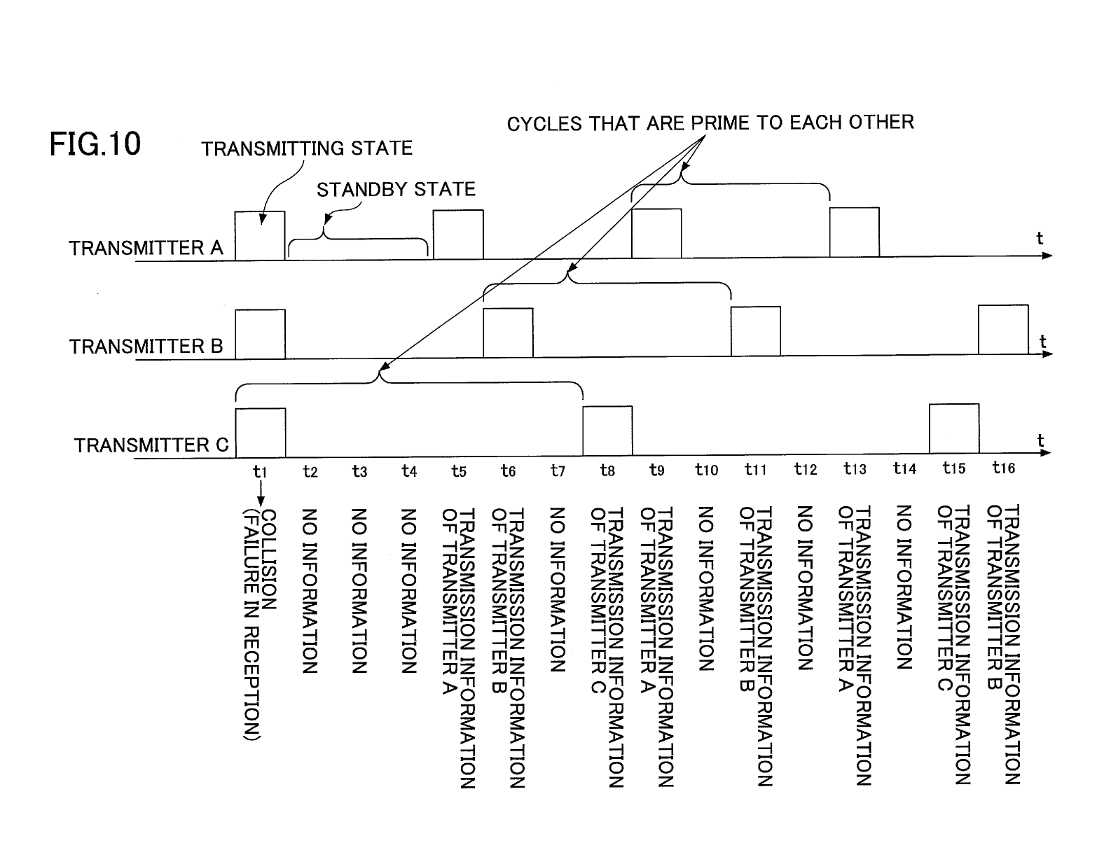

Next, transmission timing at which the transmitters 100 transmit transmission information is described. FIG. 10 is a timing chart illustrating transmission timing at which the transmitters 100 transmit transmission information (optical signals) including a random value and an identifier.

In FIG. 10, the three transmitters 100 are referred to as transmitters A, B, and C, respectively. Also in FIG. 10, rectangles indicate a transmitting state where the transmitters A, B, and C transmit transmission information and spaces between the rectangles indicate a standby state where the transmitters A, B, and C do not transmit transmission information. The transmission timing is managed by the timing generator 204.

At time t₁, all of the three transmitters A, B, and C are in the transmitting state, i.e., three sets of transmission information are being transmitted concurrently. Accordingly, the three sets of transmission information (or three optical signals) interfere with each other and the receiver 102 cannot properly receive the transmission information. Hereafter, this phenomenon is referred to as a “collision” (reception failure).

Because the transmitters A, B, and C operate independently from each other, it is difficult to prevent the collision. Although it is possible to prevent the collision by configuring the transmitters 100 to communicate and synchronize with each other and determine the transmission timing, this may complicate the configuration of the transmitters 100 and result in increased costs. For this reason, in the present embodiment, it is assumed that the transmitters 100 are not configured to synchronize with each other. Still, however, the transmitters 100 may be configured to synchronize with each other.

According to the present embodiment, the transmitters 100 intermittently transmit transmission information to minimize the occurrence of the collision. More specifically, transmission cycles at which the transmitters 100 transmit transmission information are determined such that the transmission cycles are prime to each other.

In the example of FIG. 10, the transmission cycle of the transmitter A is set at “once in four time units”, the transmission cycle of the transmitter B is set at “once in five time units”, and the transmission cycle of the transmitter C is set at “once in seven time units”.

With this configuration, the collision occurs only once in the least common multiple of the transmission cycles of the transmitters. In the example of FIG. 10, the collision occurs first at time t₁. After no-information periods (t₂ through t₄), the transmission information of the transmitter A is transmitted at time t₅.

Then, the transmission information of the transmitter B is transmitted at time t₆, and the transmission information of the transmitter C is transmitted at time t₈. Thus, this configuration makes it possible to reduce the occurrence of the collision of transmission information and thereby enables the receivers 102 to receive transmission information, i.e., key information, at a high frequency.

### <Transmission Information>

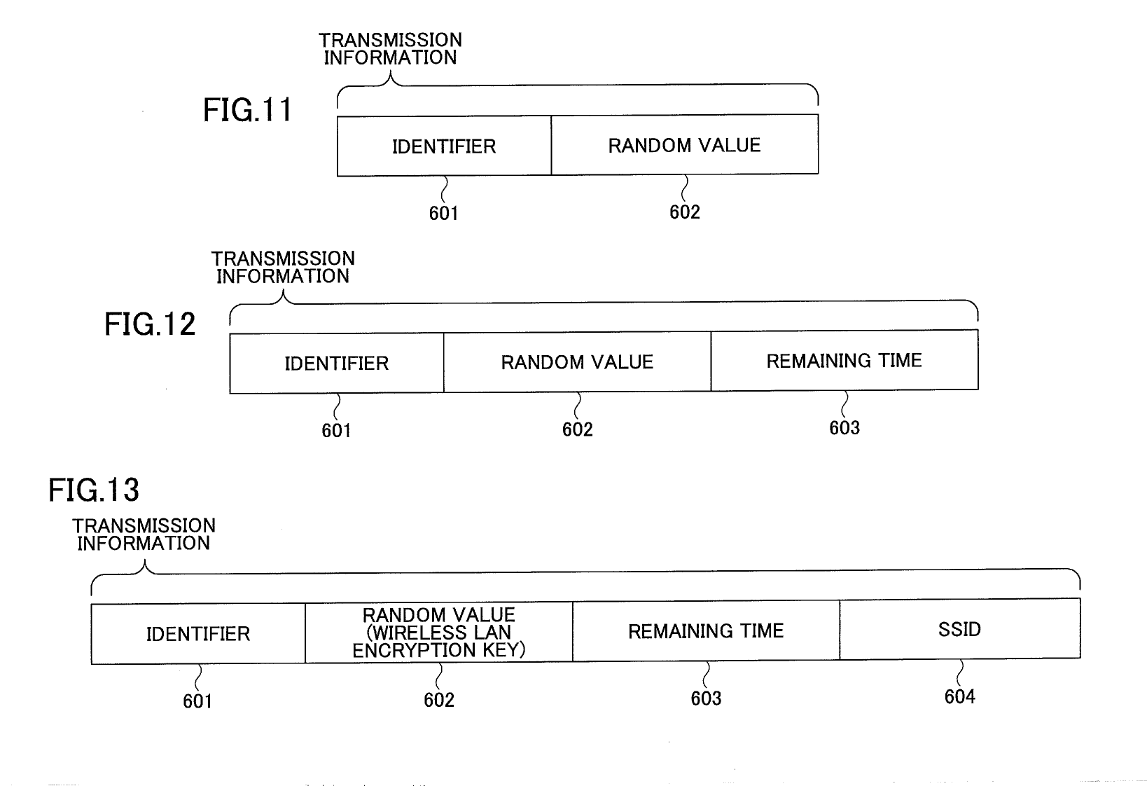

Next, an exemplary data structure of transmission information transmitted by the transmitter 100 is described. FIG. 11 is a drawing illustrating an example of transmission information. As illustrated by FIG. 11, the transmission information may include an identifier (identification information) 601 of the transmitter 100 and a random value 602. The identifier 601 uniquely identifies the transmitter 100 and is stored in the identification information storage unit 202. The random value 602 is generated by the random number generator 201.

FIG. 12 is a drawing illustrating another example of transmission information. Generally, an encryption key used for encrypted communications needs to be updated (or changed) regularly or the security of the encrypted communications is compromised. For this reason, also in the wireless communication system of the present embodiment, it is preferable to update or change the encryption key regularly.

According to the present embodiment, random values, which are transmitted by the transmitters 100 and received by the receivers 102, are updated regularly so that the encryption key used by the terminals 103 are updated regularly.

Here, however, because the terminals 103 generally operate asynchronously with each other and have different processing speeds, it is difficult to distribute random values to the terminals 103 strictly at the same time to update the encryption key.

This may cause an old encryption key and a new encryption key to coexist for a certain period of time after the random values are updated, and as a result the terminals 103 become unable to perform encrypted communications for that period of time. This problem becomes more serious as the frequency of updating the random values increases.

To prevent the above problem, the transmission information may include a remaining time 603 in addition to the identifier 601 and the random value 602 as illustrated by FIG. 12. The remaining time 603 indicates a period of time after which the random value 602 is used for an encryption key.

For example, the random number generator 201 updates the random number at predetermined timing (or predetermined intervals). The predetermined timing (or predetermined intervals) may be set by the user. After updating the random number, the random number generator 201 reports it to the timing generator 204.

For example, the remaining time 603 may be managed by the timing generator 204. The timing generator 204 may be configured to start counting down a remaining time when the random number is updated and cause the switching unit 203 to include the counted-down remaining time, i.e., time that is left when a transmission request is sent to the switching unit 203, in the transmission information.

The receiver 102 receives the transmission information of FIG. 12 and sends the transmission information to the terminal 103 as key information. Based on the remaining time 603 in the key information, the terminal 103 can determine, in advance, that the encryption key is to be updated. Thus, this configuration makes it possible to reduce the period of time during which encrypted communications cannot be performed.

Here, wireless local area networks (LAN) based on IEEE 802.11 standards are widely used. The IEEE 802.11 standards define encryption functions that make it possible to perform secure wireless communications between terminals where an encryption key is specified. An encryption key specification method according to the IEEE 802.11 standards may be applied to the wireless communication system of the present embodiment.

FIG. 13 is a drawing illustrating another example of transmission information. As illustrated by FIG. 13, the transmission information may also include a service set identifier (SSID) 604. The transmitter 100 may be configured to transmit an SSID of the corresponding wireless LAN to improve the user convenience in communications according to the IEEE 802.11 standards and higher (or successor) standards of the IEEE 802.11 standards.

This configuration enables the terminal 103 to receive an SSID to be assigned to an interface (I/F) supporting the IEEE 802.11 standards and thereby perform encrypted communications within a closed network. Also, this configuration makes it possible to eliminate the need for the user to manually set the SSID.

The SSID 604 included in the transmission information may be stored in advance in the transmitter 100. For this purpose, the transmitter 100 may include an SSID storage unit, and the switching unit 203 may be configured to read the SSID from the SSID storage unit and include SSID in the transmission information.

### <Operations>

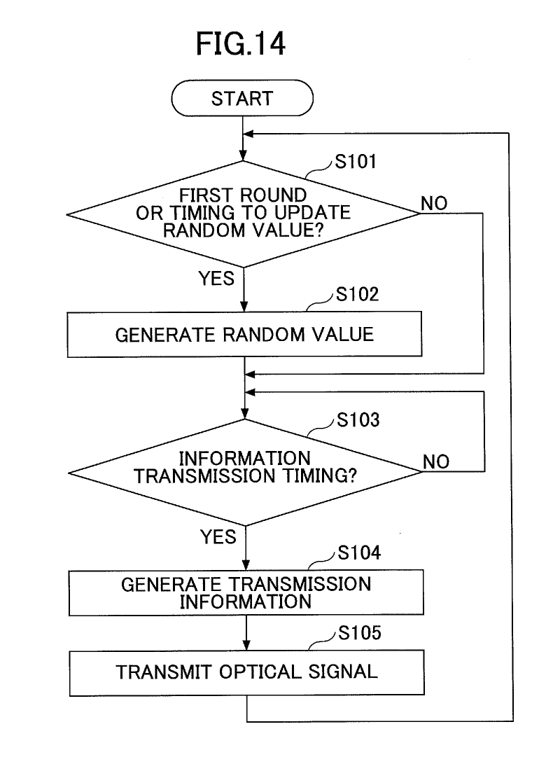

Next, operations of apparatuses constituting the wireless communication system of the present embodiment are described. FIG. 14 is a flowchart illustrating an exemplary transmission process performed by the transmitter 100.

At step S101 of FIG. 14, the random number generator 201 determines whether it is one of the first round of the process and the time to update a random value. When it is one of the first round of the process and the time to update a random value (YES at step S101), the process proceeds to step S102. When it is neither the first round of the process nor the time to update a random value (NO at step S101), the process proceeds to step S103.

At step S102, the random number generator 201 generates a random value. At step S103, the timing generator 204 determines whether it is a transmission timing to transmit transmission information. For example, the transmission timing is determined based on a transmission cycle of the transmitter 100 that is prime to the transmission cycles of other transmitters 100. When it is the transmission timing (YES at step S103), the process proceeds to step S104. On the other hand, when it is not the transmission timing (NO at step S103), step S103 is repeated.

At step S104, the switching unit 203 generates transmission information by, for example, concatenating the identifier, the random value, and the remaining time represented by bit sequences. When a wireless LAN is used for communications, the switching unit 203 may also include an SSID in the transmission information.

At step S105, the transmission information is modulated by the serial converter 205 and the modulator 206 and transmitted by the light source 207 as an optical signal. Thus, the transmitter 100 can transmit, with a simple configuration, the transmission information based on which an encryption key is generated.

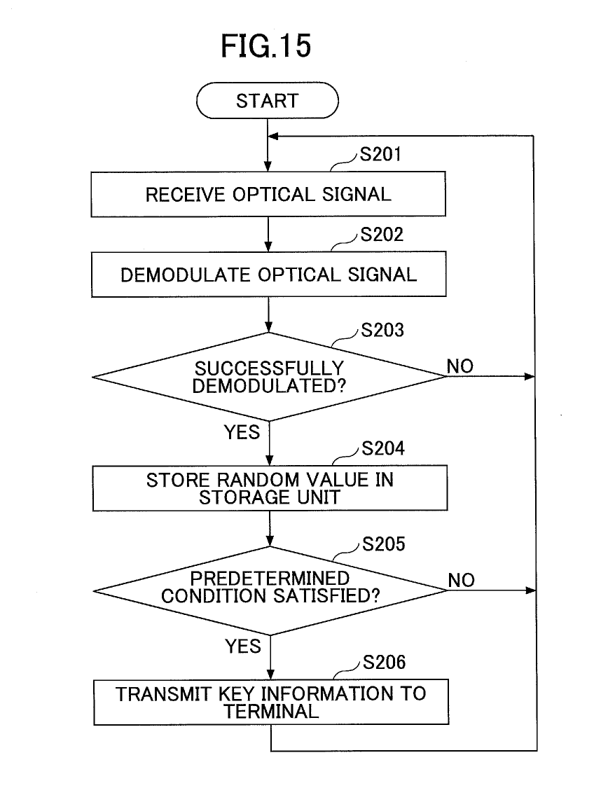

FIG. 15 is a flowchart illustrating an exemplary reception process performed by the receiver 102. At step S201 of FIG. 15, the light receiver 303 receives an optical signal transmitted from each transmitter 100.

At step S202, the demodulator 304 demodulates the optical signal into a bit sequence. At step S203, the demodulator 304 determines whether the optical signal has been successfully demodulated. When the optical signal has been successfully demodulated (YES at step S203), the process proceeds to step S204. When the optical signal has not been successfully demodulated (i.e., when the demodulation has failed) (NO at step S203), the process returns to step S201.

At step S204, the recording unit 305 extracts an identifier and a random value from the demodulated bit sequence, and stores the random value in the storage unit 306 in association with the identifier. For example, the recording unit 305 may determine the first 48 bits of the demodulated bit sequence as the identifier. Steps S201 through S204 are performed for the respective optical signals transmitted from multiple transmitters 100.

At step S205, the host communication unit 308 determines whether one of predetermined conditions for transmission is satisfied. The predetermined conditions include, for example, 1) key information has not been sent to the terminal 103, 2) the key information (or the random values) has been updated, and 3) the remaining time 603 is included in the transmission information. When one of the predetermined conditions is satisfied (YES at step S205), the process proceeds to step S206. When none of the predetermined conditions is satisfied (NO at step S205), the process returns to step S201.

At step S206, the host communication unit 308 generates key information by, for example, concatenating the random values stored in the storage unit 306 and sends the key information to the terminal 103. When the remaining time 603 is included in the transmission information, the host communication unit 308 includes the remaining time 603 in the key information.

Through the above process, the receiver 102 can send key information generated based on random values received from the transmitters 100 to the terminal 103.

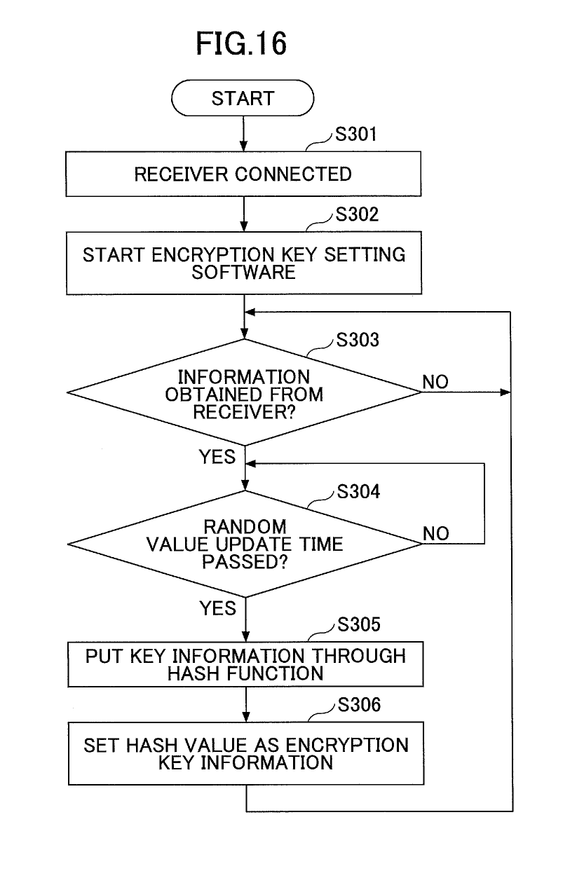

FIG. 16 is a flowchart illustrating an exemplary communication setting process performed by the terminal 103 according to the first embodiment. At step S301 of FIG. 16, the host communication unit 401 detects that the receiver 102 has been connected to the terminal 103.

At step S302, the controller 402 executes encryption key setting software. The encryption key setting software has been stored, for example, in the ROM 404 via the storage medium 411. The encryption key setting software is an application program for setting an encryption key. Steps described below are performed by the functional units illustrated in FIG. 7, which are implemented by executing the encryption key setting software.

At step S303, the obtaining unit 502 determines whether key information has been obtained (or received) from the receiver 102. When the key information has been obtained (YES at step S303), the process proceeds to step S304. When the key information has not been obtained (NO at step S303), step S303 is repeated.

At step S304, the encrypted communication controller 504 determines whether an update time for updating the random value (or the key information) has passed. For example, the encrypted communication controller 504 starts counting down the remaining time 603 when it is obtained and determines that the update time has passed if the remaining time 603 has been counted down to 0. When the update time has passed (YES at step S304), the process proceeds to step S305. When the update time has not passed (NO at step S304), step S304 is repeated.

At step S305, the hash value calculator 544 puts the key information through a hash function. Putting the key information through the hash function indicates obtaining a hash value from the key information using the hash function.

At step S306, the encrypted communication controller 504 sets the hash value as an encryption key (or encryption information). The encrypted communication controller 504 establishes a communication connection using the encryption key. As a result, a layer 2 connection is established.

When the remaining time 603 is not included in the key information, instead of performing step S304, the encrypted communication controller 504 may determine whether the key information has been updated (or whether the key information is the same as previous key information). When the key information has been updated, the process returns to step S303. When the key information has not been updated, the process proceeds to step S305.

This configuration makes it possible to determine whether the key information has been updated even when the remaining time 603 is not included in the key information and thereby makes it possible to update the encryption key as necessary.

As described above, the first embodiment makes it possible to easily and quickly perform authentication and perform secure communications in a given (or limited) area that is not necessarily a closed space. For example, once a connection is established according to the first embodiment, it is possible to exchange confidential files used in a meeting via secure communications.

When the number of transmitters 100 is predetermined, the terminal 103 may be configured to determine whether random values corresponding to the number of transmitters 100 have been obtained and to suspend the remaining process until random values corresponding to the number of transmitters 100 are obtained.

### Second Embodiment

Next, a wireless communication system according to a second embodiment is described. In the second embodiment, whether sets of key information received by the terminals 103 are the same is determined first and a common encryption key is generated when the sets of key information are the same. This method makes it possible to reliably perform encrypted communications among terminals 103 that received the same key information. Also, this method can be easily implemented by using known technologies.

### <System, Transmitter, and Receiver>

The configurations of the wireless communication system, the transmitter 100, and the receiver 102 of the second embodiment are substantially the same as those of the first embodiment. Therefore, in the descriptions below, the same reference numbers as in the first embodiment are used for the corresponding components.

### <Terminal>

The configuration of the terminal 103 of the second embodiment is substantially the same as that illustrated by FIG. 6 in the first embodiment except for the configuration of the controller 402. Therefore, in the descriptions below, the same reference numbers as in FIG. 6 are used for the corresponding components.

### <Functional Configuration>

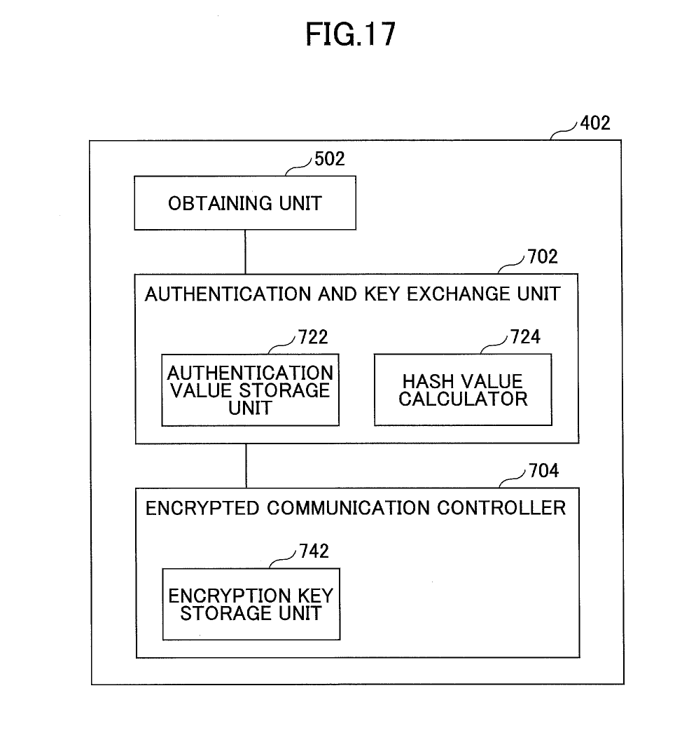

FIG. 17 is a block diagram illustrating an exemplary functional configuration of the controller 402 according to the second embodiment. As illustrated by FIG. 17, the controller 402 of the second embodiment may include an obtaining unit 502, an authentication and key exchange unit 702, and an encrypted communication controller 704. Similarly to the first embodiment, the obtaining unit 502 obtains or receives key information from the receiver 102.

The authentication and key exchange unit 702 receives the key information from the obtaining unit 502 and stores the key information as a common authentication value in an authentication value storage unit 722. The authentication and key exchange unit 702 communicates with other terminals 103 and performs an authentication process to determine whether the common authentication values stored in the terminals 103 including the terminal 103 of its own are the same.

When the common authentication values are the same, the authentication and key exchange unit 702 generates an encryption key common to the terminals 103 and exchanges the encryption key (encryption key information) with the other terminals 103. The encryption key may be generated based on the common authentication value. The authentication and key exchange unit 702 sends the generated encryption key to the encrypted communication controller 704. The encrypted communication controller 704 stores the encryption key in an encryption key storage unit 742. The common authentication value is used, for example, as a pass phrase in the Wi-Fi Protected Access (WPA).

The encrypted communication controller 704 performs encrypted communications with other terminals 103 using the common encryption key as in the first embodiment.

Here, the number of random values received from the transmitters 100 corresponds to the number of the transmitters 100. Accordingly, the length of the common authentication value generated based on the random values increases as the number of the transmitters 100 increases. For this reason, the authentication and key exchange unit 702 may use a hash function that outputs a fixed-length bit sequence to make the length of the common authentication value constant.

A hash value calculator 724 of the authentication and key exchange unit 702 calculates a fixed-length hash value of the common authentication value using a hash function and stores the hash value as a new common authentication value in the authentication value storage unit 722.

With the above configuration, the encrypted communication controllers 704 of the terminals 103 can store a common encryption key and can perform encrypted communications with each other using the common encryption key.

### <Operations>

Next, operations of apparatuses constituting the wireless communication system of the second embodiment are described. Operations of the transmitter 100 of the second embodiment are substantially the same as those described with reference to FIG. 14. Operations of the receiver 102 of the second embodiment are substantially the same as those described with reference to FIG. 15.

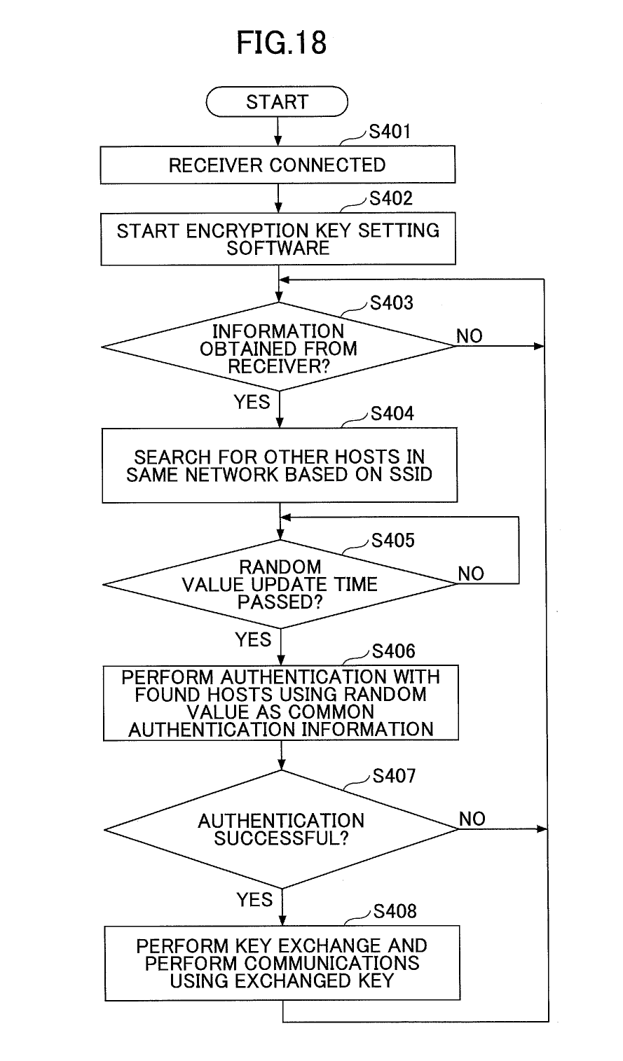

FIG. 18 is a flowchart illustrating an exemplary communication setting process performed by the terminal 103 according to the second embodiment. In FIG. 18, it is assumed that a wireless LAN is used and the transmission information illustrated by FIG. 13 is transmitted from each transmitter 100.

Steps S401 through S403 of FIG. 18 are substantially the same as steps S301 through S303 of FIG. 16.

At step S404, the authentication and key exchange unit 702 searches for other hosts (terminals 103) in the same network based on an SSID obtained together with a random value (or key information).

At step S405, the authentication and key exchange unit 702 determines whether an update time for updating the random value (or the key information) has passed. When the update time has passed (YES at step S405), the process proceeds to step S406. When the update time has not passed (NO at step S405), step S405 is repeated.

At step S406, the authentication and key exchange unit 702 performs an authentication process with the hosts found based on the SSID using the random value as a common authentication value.

At step S407, the authentication and key exchange unit 702 determines whether the authentication process has been successful, i.e., whether the found hosts have the same common authentication value as the terminal 103 of its own. When the authentication process has been successful (YES at step S407), the process proceeds to step S408. When the authentication process has not been successful (NO at step S407), the process returns to step S403.

At step S408, the authentication and key exchange unit 702 performs a key exchange to exchange a common encryption key with the found hosts according to the result of the authentication process. The encrypted communication controller 704 performs encrypted communications using the exchanged common encryption key. In the example of FIG. 18, it is assumed that an SSID is used. However, a communication setting process of the terminal 103 of the second embodiment may also be performed without using an SSID.

As described above, the second embodiment makes it possible to easily and quickly perform authentication and perform secure communications in a given (or limited) area that is not necessarily a closed space. The second embodiment also makes it possible to reliably perform encrypted communications among terminals 103 that received the same key information. Also, the method of the second embodiment can be easily implemented by using known technologies.

Exemplary communication methods that can be used for the first and second embodiments include infrared communication, Bluetooth (registered trademark), and near field communication (NFC). The terminal 103 may be implemented, for example, by a personal computer (PC), a smartphone, a tablet terminal, and a portable game machine.

Programs to be executed on the terminal 103 may be provided in a non-transitory, computer-readable storage medium such as a CD-ROM, a flexible disk (FD), a CD-R, or a digital versatile disk (DVD), and installed into the terminal 100 from the storage medium.

Also, programs to be executed on the terminal 103 may be downloaded and installed from a computer connected to a network such as the Internet. Also, programs to be executed on the terminal 103 may be distributed via a network such as the Internet.

Further, programs to be executed on the terminal 103 may be pre-stored, for example, in a ROM of the terminal 103.

Programs to be executed on the terminal 103 may be provided as modules corresponding to the functional units of the terminal 103 described above. The programs may be read from a ROM or an HDD into a RAM and executed by a CPU to implement the functional units of the terminal 103.

A wireless communication system, a terminal, and a storage medium according to embodiments of the present invention are described above. However, the present invention is not limited to the specifically disclosed embodiments, and variations and modifications may be made without departing from the scope of the present invention. Also, the above described embodiments and parts of the embodiments may be combined in any appropriate manner.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Because the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A wireless communication system, comprising:
a plurality of transmitters each configured to transmit transmission information including a code and an identifier of a corresponding transmitter; and
a plurality of terminals configured to wirelessly communicate with each other,
wherein each of the terminals includes
an obtaining unit that obtains codes extracted from multiple sets of the transmission information transmitted from the transmitters, and
a communication unit that performs encrypted communications with other terminals using the obtained codes.

2. The wireless communication system as claimed in claim 1, wherein
each of the terminals stores the codes as a common encryption key, and
the communication unit performs the encrypted communications with the other terminals using the common encryption key.

3. The wireless communication system as claimed in claim 1,
wherein each of the terminals further includes an authentication and key exchange unit that performs an authentication process with the other terminals using the codes as a common authentication value and exchanges a common encryption key with the other terminals; and
wherein the communication unit performs the encrypted communications with the other terminals using the common encryption key.

4. The wireless communication system as claimed in claim 1, wherein the transmitters transmit the transmission information intermittently.

5. The wireless communication system as claimed in claim 4, wherein the transmitters transmit the transmission information at different transmission cycles that are prime to each other.

6. The wireless communication system as claimed in claim 1, wherein when the code is updated, each of the transmitters transmits the transmission information that includes the updated code, the identifier, and a period of time after which the updated code is used for an encryption key.

7. The wireless communication system as claimed in claim 1, wherein when the terminals wirelessly communicate with each other according to IEEE 802.11 standards or higher standards of the IEEE 802.11 standards, each of the transmitters adds a network SSID to the transmission information.

8. The wireless communication system as claimed in claim 1, wherein the communication unit is able to perform the encrypted communications within a range where transmission ranges of the transmitters overlap each other.

9. A terminal, comprising:
an obtaining unit that obtains codes extracted from multiple sets of transmission information transmitted from a plurality of transmitters; and
a communication unit that performs encrypted communications with other terminals using the obtained codes.

10. A non-transitory computer-readable storage medium storing a program for causing a computer to perform a method, the method comprising:
obtaining codes from multiple sets of transmission information transmitted from a plurality of transmitters; and
performing encrypted communications with other computers using the obtained codes.
